(19) United States
(12) Patent Application Publication
(10) Pub. No.: US 2012/0318550 A1
(43) Pub. Date: Dec. 20, 2012

(54) IMPACT TOOL

(75) Inventors: Hideyuki Tanimoto, Ibaraki (JP); Nobuhiro Takano, Ibaraki (JP); Tomomasa Nishikawa, Ibaraki (JP); Kazutaka Iwata, Ibaraki (JP); Hironori Mashiko, Ibaraki (JP); Hayato Yamaguchi, Ibaraki (JP)

(73) Assignee: HITACHI KOKI CO., LTD., Tokyo (JP)

(21) Appl. No.: 13/579,846

(22) PCT Filed: Mar. 11, 2011
(86) PCT No.: PCT/JP2011/056505

§ 371 Date: Aug. 17, 2012

(30) Foreign Application Priority Data
Mar. 11, 2010 (JP) 2010-055011

(51) Int. Cl. B25B 23/147

(52) U.S. Cl. 173/117

(57) ABSTRACT

An impact tool including: a motor; a hammer connected to the motor; and an anvil struck by the hammer by driving the motor alternately in a normal rotation and a reverse rotation, wherein a magnitude of a fastening torque by the anvil is calculated in accordance with a current value of a current supplied to the motor immediately after the striking.

### TECHNICAL FIELD

Aspects of the present invention relate to an impact tool that is driven by a motor and realizes a new striking mechanism portion, and specifically to an impact tool that can that can detect a magnitude of a fastening torque when an impact operation is performed without providing a special detecting device.

### BACKGROUND ART

An impact tool drives a rotating striking mechanism portion by using a motor as a driving source to apply torque and a striking force to an anvil, so as to intermittently transmit a rotating impact force to an end tool perform an operation such as screwing. In recent years, a brushless DC motor is widely used as the driving source. The brushless DC motor is, for instance, a DC (direct current) motor that does not include a brush (a rectifying brush), and uses a coil (winding wire) in a stator side and a magnet (a permanent magnet) in a rotor side and sequentially supplies an electric power driven in an inverter circuit to a predetermined coil to rotate the rotor. The inverter circuit is formed by using an output transistor of a large capacity such as an FET (Field Effect Transistor) or an IGBT (Insulating Gate Bipolar Transistor) and is driven by a large current. The brushless DC motor has better torque characteristics than that of a DC motor with a brush, and can fasten a screw, a bolt, etc. to a processed member by a stronger force.

JP-A-2009-72888 discloses an example of the impact tool using the brushless DC motor. In JP-A-2009-72888, the impact tool has a continuously rotating type impact mechanism portion. When a torque is applied to a spindle through a power transmitting mechanism portion (a speed-reduction mechanism portion), a hammer, which is engaged with the spindle so as to be movable in a direction of a rotary shaft of the spindle, is rotated, so as to rotate an anvil abutting to the hammer. The hammer and the anvil respectively have two hammer protruding portions (striking portions) which are respectively arranged symmetrically with each other at two positions on a rotation plane. These protruding portions are located at positions where the protruding portions are engaged with each other in a rotating direction. A rotating striking force is transmitted in accordance with the engagement of the protruding portions. The hammer is provided so as to freely slide in the axial direction relative to the spindle within a ring area that surrounds the spindle. An inverted V-shaped (substantially triangular shape) cam groove is provided to an inner peripheral surface of the hammer. A V-shaped cam groove is provided in the axial direction to an outer peripheral surface of the spindle. The hammer is rotated via balls (steel balls) inserted between the cam groove provided to the spindle and the cam groove provided to the hammer.

### SUMMARY OF INVENTION

### Technical Problem

In the related-art power transmitting mechanism portion, the spindle and the hammer are supported via the balls arranged in the cam grooves. The hammer can be retreated rearward in the axial direction relative to the spindle by a spring arranged at a rear end thereof. Accordingly, the hammer is indirectly driven by a motor through a cam mechanism. Thus, the number of parts in a power transmitting part from the spindle to the hammer becomes large, thereby increasing a manufacturing cost. Further, it was difficult to reduce size of a tool main body.

On the other hand, in a fastening operation using an impact mechanism in an impact tool, an accurate fastening operation is desired to be carried out by a predetermined fastening torque. In that case, a torque detecting unit such as a distortion gauge or a rotation transformer is provided in a spindle shaft to detect a torque during an impact. However, to provide the torque detecting unit prevents the impact tool main body from being reduced in size. Further, the increase of the number of parts leads to the high manufacturing cost.

Accordingly, it is an object of the present invention to provide an impact tool that can realize an impact mechanism by a hammer and an anvil having simple structures and can accurately carry out a fastening operation by a predetermined fastening torque.

Another object of the present invention is to provide a compact and light impact tool that realizes a detecting unit of a fastening torque without attaching a sensor such as a distortion gauge to an anvil.

Another object of the present invention is to provide an impact tool that can accurately detect a fastening torque by detecting a current supplied to a motor immediately after a striking.

### Solution to Problem

Representative features of the invention disclosed in this application will be described as follow.

According to a first aspect of the present invention, there is provided an impact tool including, a motor; a hammer connected to the motor; and an anvil struck by the hammer by driving the motor alternately in a normal rotation and a reverse rotation, wherein a magnitude of a fastening torque by the anvil is calculated in accordance with a current value of a current supplied to the motor immediately after the striking.

Further, according to a second aspect of the present invention, in the impact tool, a driving current for driving the motor in a normal direction may be continuously supplied to the motor for a time tₐ after the striking is performed, and the current value may be detected within the time tₐ.

Further according to a third aspect of the present invention, in the impact tool, a peak current value may be detected as the current value.

Further, according to a fourth aspect of the present invention, in the impact tool, the current value may be calculated by an average of a current value after the striking and a current value after the time tₐ.

Further, according to a fifth aspect of the present invention, in the impact tool, the current value may be detected by an inclination of a current value curve.

According to a sixth aspect of the present invention, there is provided an impact tool including; a motor; a hammer connected to the motor; and an anvil struck by the hammer by driving the motor alternately in a normal rotation and a reverse rotation, wherein a fall of a rotating speed of the motor immediately after the striking is detected, and wherein a magnitude of a fastening torque by the striking is calculated from a degree of the fall.

Further, according to a seventh aspect of the present invention, in the impact tool, a driving current for rotating the motor in a normal direction may be continuously supplied for a predetermined time after the striking is performed, and the degree of the fall of the rotating speed of the motor may be detected after the supply of the driving current is stopped.

Further according to an eighth aspect of the present invention, in the impact tool, the driving current may be continuously supplied for a time tₐ after the striking is performed, and the degree of the fall of the rotating speed may be detected during a time t_{b} which starts after the time tₐ elapsed after the striking.

According to a ninth aspect of the present invention, in the impact tool, the degree of the fall of the rotating speed may be detected by an inclination of a rotating speed curve.

According to a tenth aspect of the present invention, in the impact tool, the degree of the fall of the rotating speed may be calculated by an average value of a value of the rotating speed curve after the time tₐ has elapsed and a value of the rotating speed curve after a time t, has elapsed.

### Advantageous Effects of Invention

According to the first aspect of the present invention, since the magnitude of the fastening torque by the anvil is calculated in accordance with the value of the current supplied to the motor immediately after the striking, a torque detecting unit can be realized without separately using a torque detector such as a distortion sensor, and a fastening load during an operation can be detected for each striking, which can effectively influence the control of the motor, and a fastening operation can be accurately performed.

According to the second aspect of the present invention, since the driving current of the normal rotation is continuously supplied to the motor for a time tₐ after the impact is applied, the reaction force of the impact transmitted to an operator may be reduced and the magnitude of the fastening torque can be detected by using the driving current continuously supplied to the motor. Further, since the magnitude of the fastening torque is detected within a minute time such as the time tₐ after the striking, the magnitude of the fastening torque can be rapidly detected.

According to the third aspect of the present invention, since the peak current value is detected as the current value, a current during a peak can be easily detected by using a current detecting circuit employed for a control circuit of the motor.

According to the fourth aspect of the present invention, since the current value is calculated by an average of the current after the impact and the current value after the time tₐ, the magnitude of the fastening torque can be accurately detected even when a load changes every moment depending on a fastening object or a fastened object.

According to the fifth aspect of the present invention, since the current value is detected by the inclination of the current value curve, the magnitude of the load (the fastening torque value) can be detected without using a torque sensor.

According to the sixth aspect of the present invention, since the fall of the rotating speed of the motor immediately after the striking is detected and the magnitude of the fastening torque by the striking is calculated from the degree of the fall, a torque detecting unit can be realized without separately using a torque detector such as a distortion sensor, and a fastening load during an operation can be detected for each striking so as to effectively influence the control of the motor, and a fastening operation can be accurately performed.

According to the seventh aspect of the present invention, since the driving current for rotating the motor in the normal direction is continuously supplied to the motor for a predetermined time after the striking is performed, the reaction force of the impact transmitted to an operator may be reduced. Further, the degree of the fall of the rotating speed of the motor is detected after the supply of the driving current is stopped. Thus, the fastening torque value can be detected for each striking without influencing the supply of the driving current of the motor for a striking operation.

According to the eighth aspect of the present invention, since the driving current is continuously supplied for a time tₐ after the striking is performed and the degree of the fall of a rotating speed is detected during a time t_{b} which starts after the time tₐ elapsed after the striking, a supply period of the driving current and a detecting period of the fastening torque value does not overlap each other. Thus, the fastening torque can be accurately detected.

According to the ninth aspect of the present invention, since the degree of the fall of the rotating speed is detected by the inclination of the rotating speed curve, the magnitude of the load (the fastening torque value) can be detected without using a torque sensor.

According to the tenth aspect of the present invention, since the degree of the fall of the rotating speed is calculated by the average value of the value of the rotating speed curve after the time tₐ has elapsed and the value of the rotating speed curve after the time t_{c} has elapsed, the fastening torque value can be accurately detected even when a load changes by the minute depending on a fastening object or a fastened object.

The above-described objects and other objects and novel features will become apparent from the description of the specification and drawings hereinafter.

### BRIEF DESCRIPTION OF DRAWINGS

FIG. 1 is a longitudinal sectional view showing an entire structure of an impact tool according to an exemplary embodiment of the present invention;

FIG. 2 is a perspective view showing an external appearance of the impact tool according to the exemplary embodiment of the present invention;

FIG. 3 is an enlarged sectional view of a portion in a vicinity of a striking mechanism shown in FIG. 1;

FIG. 4 is a perspective view showing the configuration of a hammer and an anvil shown in FIG. 1;

FIG. 5 is a perspective view showing the configuration of the hammer and the anvil illustrated in FIG. 1 from a different angle;

FIG. 6 is a functional block diagram showing a driving control system of a motor of the impact tool according to the exemplary embodiment of the present invention;

FIG. 7 (7A, 7B, 7C, 7D) is a sectional view taken along a line A-A in FIG. 3 to explain a driving control of the hammer in a “continuous driving mode”;

FIG. 8 (8A, 8B, 8C, 8D, 8E, 8F) is a sectional view taken along a line A-A in FIG. 3 to explain the driving control of the hammer in an “intermittent driving mode”;

FIG. 9 is a diagram showing a trigger signal during the operation of an impact tool, a driving signal to an inverter circuit, a rotating speed of a motor and a state of an impact of a hammer and an anvil;

FIG. 10 is a diagram showing a relation between the driving signal to the inverter circuit, an operating current supplied to the motor and the rotating speed of the motor in an intermittent driving mode (2) shown in FIG. 9;

FIG. 11 is a flowchart showing a control procedure in the intermittent driving mode (2) of the impact tool according to an exemplary embodiment of the present invention; and

FIG. 12 is a flowchart showing a control procedure in an intermittent driving mode (2) of an impact tool according to a second exemplary embodiment of the present invention.

### DESCRIPTION OF EMBODIMENTS

### First Exemplary Embodiment

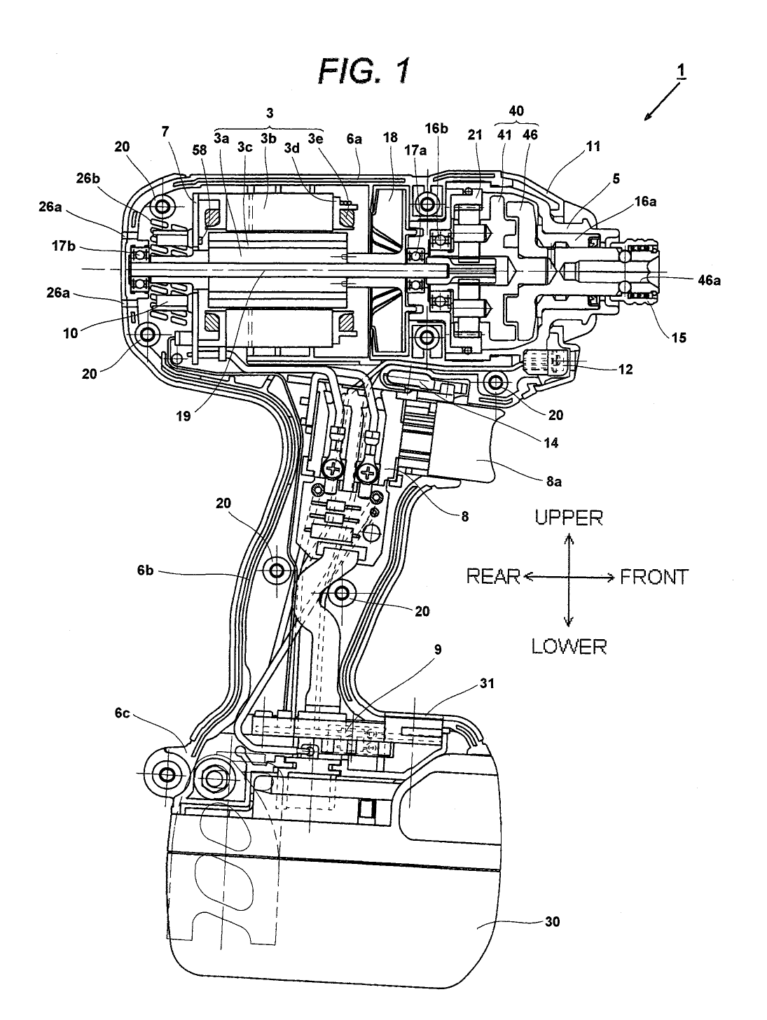

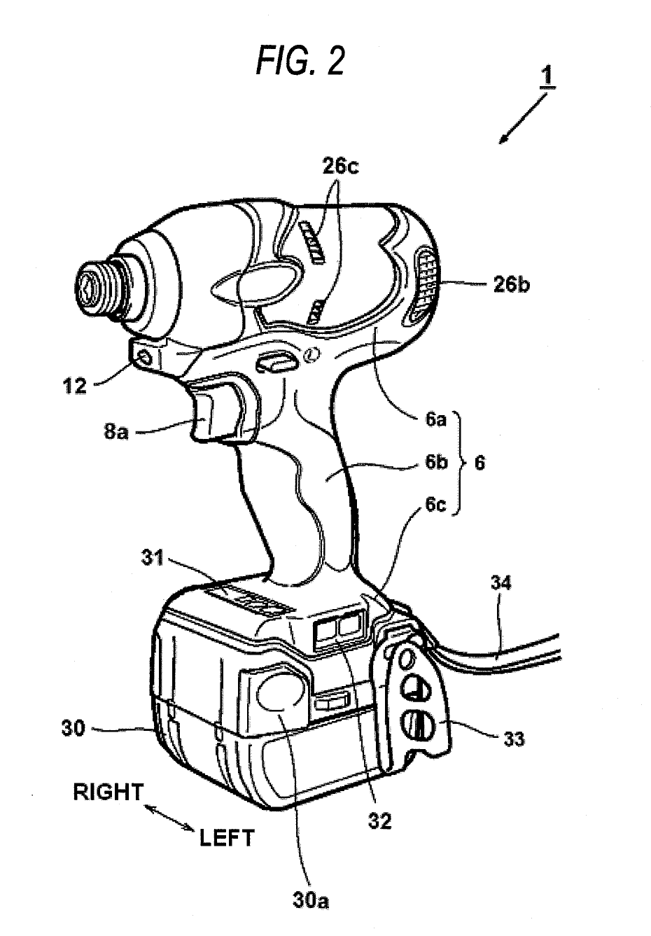

Hereinafter, an exemplary embodiment of the present invention will be described by referring to the drawings. In the following description, upper and lower directions, front and rear directions and right and left directions correspond to directions shown in FIG. 1 and FIG. 2.

FIG. 1 is a longitudinal sectional view showing an entire structure of an impact tool 1 according to the exemplary embodiment of the present invention. The impact tool 1 uses a battery pack 30 that can be charged as a power source and a motor 3 as a driving source to drive an striking mechanism 40 and rotates and an strikes an anvil 46 as an output shaft to transmit a continuous torque or an intermittent striking force to an end tool such as a driver bit not shown in the drawing so as to fasten a screw or a bolt.

The motor 3 is a brushless DC motor and accommodated in a tubular trunk portion 6a of a housing 6 (see FIG. 2) substantially formed in a T shape when seen from a side surface. The housing 6 is formed so as to be divided to two right and left members substantially symmetrical with each other and these members are fixed together by a plurality of screws. Therefore, in one of the divided housing 6 (in the exemplary embodiment, a left side housing), a plurality of screw bosses 20 are formed. In the other (a right side housing), a plurality of tapped holes (not shown in the drawing) are formed. A rotary shaft 19 of the motor 3 is supported so as to freely rotate by a bearing 17b in a rear end side of the trunk portion 6a and a bearing 17a provided in a portion in the vicinity of a central portion. In a rear portion of the motor 3, a board 7 is provided on which six switching elements 10 are mounted. An inverter is controlled by the switching elements 10 to rotate the motor 3. On a front part side of the board 7, a rotating position detecting element 58 such as a Hall element or a Hall IC is mounted to detect a position of a rotor 3a.

In an upper portion in a grip portion 6b integrally extending substantially at right angles to the trunk portion 6a of the housing 6, a trigger switch 8 and a normal/reverse switching lever 14 are provided. In the trigger switch 8, a trigger operating portion 8a is provided that is urged by a spring not shown in the drawing to protrude from the grip portion 6b. In a lower part in the grip portion 6b, a control circuit board 9 is accommodated that has a function for controlling a speed of the motor 3 by the trigger operating portion 8a. In a battery holding portion 6c formed in a lower part of the grip portion 6b of the housing 6, the battery pack 30 in which a plurality of battery cells such as nickel hydrogen or lithium ion are accommodated is detachably attached.

In a front part of the motor 3, a cooling fan 18 that is attached to the rotary shaft 19 and rotates synchronously with the motor 3 is provided. By the cooling fan 18, air is sucked from air intake ports 26a and 26b provided in a rear part of the trunk portion 6a. The sucked air is exhausted outside the housing 6 from a plurality of slits 26c (see FIG. 2) formed in the trunk portion 6a of the housing 6 and in the vicinity of an outer peripheral side in the radial direction of the cooling fan 18.

The striking mechanism 40 is formed of two portions, that is, the anvil 46 and a hammer 41. The hammer 41 is fixed so as to connect together rotary shafts of a plurality of planetary gears of a planetary gear speed-reduction mechanism 21. The hammer 41 does not include a cam mechanism having a spindle, a spring, a cam groove, a ball, etc., differently from a well-known impact mechanism which is presently widely used. The anvil 46 and the hammer 41 are connected to each other by a fitting shaft and a fitting hole formed in a vicinity of a center of rotation, so that only less than one relative rotation can be performed therebetween. The anvil 46 is formed integrally with an output shaft portion to which the end tool not shown in the drawing is attached. In a front end of the anvil, an attaching hole 46a that has a hexagonal cross-sectional shape in an axial direction is formed. A rear side of the anvil 46 is connected to a fitting shaft of the hammer 41 and supported so as to freely rotate relative to a case 5 by a metal bearing 16a in a part near a central portion in the axial direction.

The case 5 is integrally formed from metal to accommodate the striking mechanism 40 and the planetary gear speed-reduction mechanism 21, and attached to the front side of the housing 6. Further, an outer peripheral side of the case 5 is covered with a cover 11 made of a resin to prevent the transmission of heat and achieve an impact absorbing effect. In an end of the anvil 46, an end tool holding unit is formed for holding the end tool. The end tool is detached and attached by moving a sleeve 15 forward and backward.

In the impact tool 1, when the trigger operating portion 8a is pulled to start driving the motor 3, a speed of the rotation of the motor 3 is reduced by the planetary gear speed-reduction mechanism 21 and the hammer 41 is directly driven at a rotating speed in a predetermined ratio to the rotating speed of the motor 3. When the hammer 41 is rotated, its torque is transmitted to the anvil 46, so that the anvil 46 starts to rotate at the same speed as that of the hammer 41.

FIG. 2 is a perspective view showing an external appearance of the impact tool 1 shown in FIG. 1. The housing 6 is formed with three portions (6a, 6b and 6c). In the vicinity of the outer peripheral side in the radial direction of the cooling fan 18, the slits 26c are formed for exhausting cooling air. Further, in an upper surface of the battery holding portion 6c, a control panel 31 is provided. On the control panel 31, various kinds of operating buttons or display lamps are arranged. For instance, a switch for turning an LED light 12 on and off or a button for recognizing a residual amount of the battery pack 30 is arranged. Further, on a side surface of the battery holding portion 6c, a button switch 32 is provided for switching an operation mode (a drill mode, an impact mode) of the impact tool 1. When an operator presses the button switch 32 rightward, the drill mode and the impact mode are alternately switched.

In the battery pack 30, a release button 30a is provided. The battery pack 30 can be detached from the battery holding portion 6c by pressing release buttons 30a located at both right and left sides while moving the battery pack 30 forward. In right and left sides of the battery holding portion 6c, detachable belt hooks 33 made of metal are provided. In FIG. 2, the belt hook is attached to the left side of the impact tool 1. However, the belt hook 33 may be detached and attached to the right side of the impact tool 1. In the vicinity of a rear end part of the battery holding portion 6c, a strap 34 is attached.

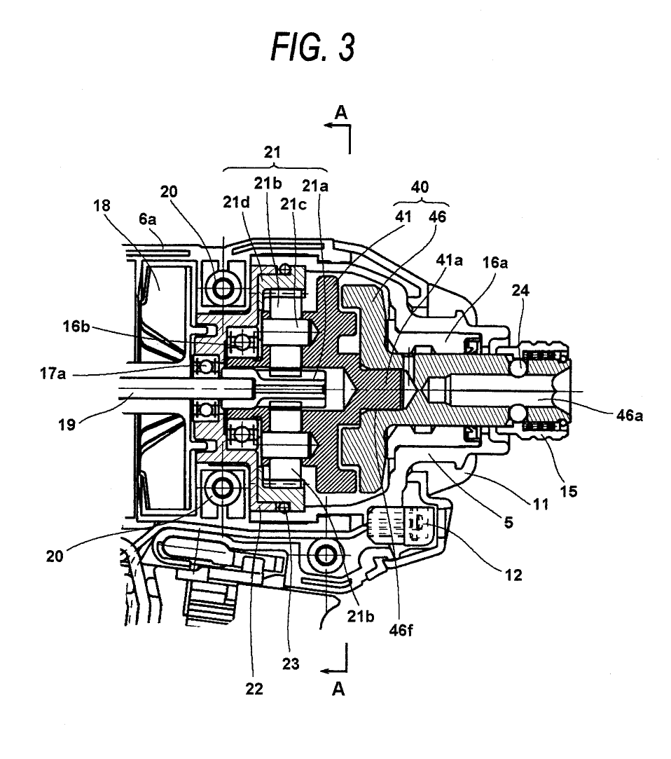

FIG. 3 is an enlarged sectional view of a part near the striking mechanism 40 shown in FIG. 1. The planetary gear speed-reduction mechanism 21 is a planetary type, and a sun gear 21a connected to an end of the rotary shaft 19 of the motor 3 serves as a driving shaft (an input shaft) and a plurality of planetary gears 21b rotate in an outer gear 21d fixed to the trunk portion 6a. A plurality of rotary shafts 21c of the planetary gears 21b is supported by the hammer 41 having a function of a planetary carrier. The hammer 41 rotates in the same direction as that of the motor 3 in a predetermined reduction gear ratio as a driven shaft (an output shaft) of the planetary gear speed-reduction mechanism 21. The reduction gear ratio may be suitably set based on factors such as a main object to be fastened (a screw or a bolt), an output of the motor 3 and a necessary fastening torque, etc. In the exemplary embodiment, the reduction gear ratio is set so that the rotating speed of the hammer 41 is about ⅛ to 1/15 times of the rotating speed of the motor 3.

In an inner peripheral side of the two screw bosses 20 in the trunk portion 6a, an inner cover 22 is provided. The inner cover 22 is manufactured by integral molding of synthetic resin such as plastic. In a rear part, a cylindrical portion is formed. The cylindrical portion holds the bearing 17a that fixes the rotary shaft 19 of the motor 3 so as to freely rotate. Further, in a front side of the inner cover 22, two cylindrical stepped portions which have different diameters are provided. In a small stepped portion, a ball type bearing 16b is provided. In a large cylindrical stepped portion, a portion of the outer gear 21d is inserted from a front side. Since the outer gear 21d is attached to the inner cover 22 so as not to freely rotate and the inner cover 22 is attached to the trunk portion 6a of the housing 6 so as not to freely rotate, the outer gear 21d is fixed to the housing 6 in a non-rotating state. Further, in an outer peripheral portion of the outer gear 21d, a flange portion is provided whose outside diameter is formed to be large. Between the flange portion and the inner cover 22, an O ring 23 is provided. To a rotating portion of the hammer 41 and the anvil 46, grease (not shown in the drawing) is provided. The O ring 23 performs sealing so that the grease does not leak to the inner cover 22 side.

In the exemplary embodiment, the hammer 41 functions as a planetary carrier that holds the plurality of rotary shafts 21c of the planetary gears 21b. Therefore, a rear end part of the hammer 41 is extended to an inner peripheral side of an inner ring of the bearing 16b. Further, an inner peripheral part of a rear side of the hammer 41 is arranged in an inner cylindrical space for accommodating the sun gear 21a attached to the rotary shaft 19 of the motor 3. In the vicinity of a central axis in the front side of the hammer 41, a fitting shaft 41a is formed as a shaft portion protruding forward in the axial direction. The fitting shaft 41a is fitted to a cylindrical fitting hole 46f formed in the vicinity of a central axis in a rear side of the anvil 46. The fitting shaft 41a and the fitting hole 46f are supported so as to be relatively rotated to each other.

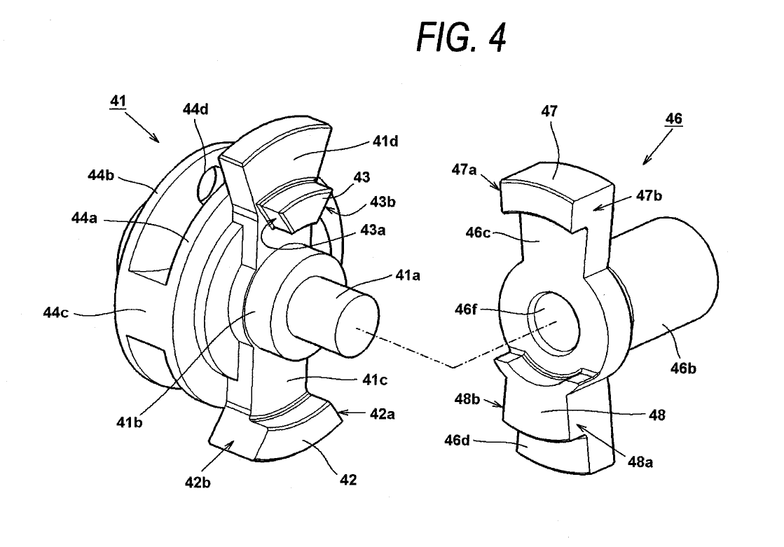

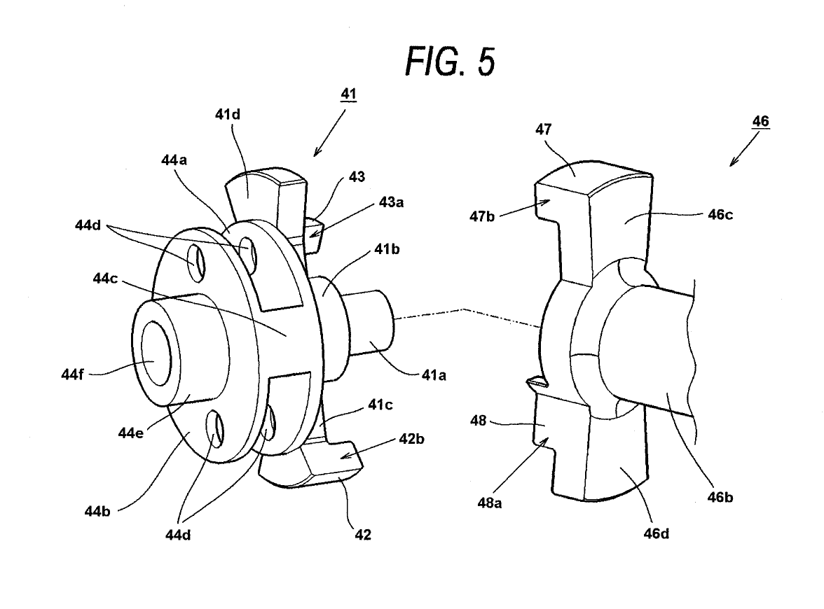

Hereinafter, referring to FIGS. 4 and 5, a detailed structure of the striking mechanism 40 shown in FIGS. 1 and 2 will be described. FIG. 4 is a perspective view showing the configuration of the hammer 41 and the anvil 46 according to the exemplary embodiment of the present invention. In FIG. 4, the hammer 41 is viewed from an obliquely front part and the anvil 46 is viewed from an obliquely rear part. FIG. 5 is a perspective view showing the configuration of the hammer 41 and the anvil 46 and shows a view in which the hammer 41 is viewed from an obliquely rear part and a partial view in which the anvil 46 is viewed from an obliquely front part. The hammer 41 includes two blade portions 41c and 41d diametrically protruding from a cylindrical main body portion 41b. The blade portions 41d and 41c respectively include protruding portions protruding in the axial direction. Further, the blade portions 41c and 41d respectively include one set of striking portions and spindle portions.

An outer peripheral portion of the blade portion 41c is formed so as to expand in a sector shape. A protruding portion 42 which protrudes forward in the axial direction from is formed to the outer peripheral part of the blade portion 41c. The portion expanding in the sector shape and the protruding portion 42 function as the striking portion (striking pawl) and function as the spindle portion at the same time. In both sides in the circumferential direction of the protruding portion 42, striking-side surfaces 42a and 42b are formed. Both the striking-side surfaces 42a and 42b are formed in a plane and have suitable angles so as to effectively come into face contact with a struck-side surface of the anvil 46, which will be described later. On the other hand, in the blade portion 41d, an outer peripheral part is formed so as to expand in a sector shape. Therefore, the mass of the outer peripheral part of the blade portion 41d becomes large, so as to serve as the spindle portion. Further, a protruding portion 43 that protrudes forward in the axial direction from a part in the vicinity of a central portion in the diametrical direction of the blade portion 41d is formed. The protruding portion 43 serves as the striking portion (striking pawl). At both sides in the circumferential direction, striking-side surfaces 43a and 43b are formed. Both the striking-side surfaces 43a and 43b are formed in a plane and have suitable angles in the circumferential direction so as to effectively come into face contact with the struck-side surface of the anvil 46, which will be described later.

In the vicinity of the axis of the main body portion 41b and in the front side, the fitting shaft 41a that is fitted to the fitting hole 46f of the anvil 46 is formed. In a rear side of the main body portion 41b, two disk portions 44a and 44b and connecting portions 44c, which connect the disk portions together at two positions in the circumferential direction, are formed, so as to have the function of the planetary carrier. In the two positions respectively in the circumferential directions of the disk portions 44a and 44b, through holes 44d are formed. Between the disk portions 44a and 44b, the two planetary gears 21b (see FIG. 3) are arranged and the rotary shafts 21c (see FIG. 3) of the planetary gears 21b are attached to the through holes 44d. In a rear side of the disk portion 44b, a cylindrical portion 44e which extends in a cylindrical shape is formed. An outer peripheral side of the cylindrical portion 44e is supported by the inner ring of the bearing 16b. Further, in an inner space 44f of the cylindrical portion 44e, the sun gear 21a (see FIG. 3) is arranged. The hammer 41 and the anvil 46 shown in FIG. 4 and FIG. 5 are preferably formed by integral molding of metal in view of strength and weight.

The anvil 46 includes two blade portions 46c and 46d protruding in the diametrical direction from a cylindrical main body portion 46b. In the vicinity of an outer periphery of the blade portion 46c, a protruding portion 47 is formed which protrudes rearward in the axial direction. In both sides in the circumferential direction of the protruding portion 47, struck-side surfaces 47a and 47b are formed. On the other hand, in the vicinity of a central portion in the diametrical direction of the blade portion 46d, a protruding portion 48 which protrudes rearward in the axial direction is formed. In both sides in the circumferential direction of the protruding portion 48, struck-side surfaces 48a and 48b are formed. When the hammer 41 is normally rotated (rotated in a direction for fastening the screw), the striking-side surface 42a abuts on the struck-side surface 47a and the striking-side surface 43a abuts on the struck-side surface 48a at the same time. Further, when the hammer 41 is reversely rotated (rotated in a direction for unfastening the screw), the striking-side surface 42b abuts on the struck-side surface 47b and the striking-side surface 43b abuts on the struck-side surface 48b at the same time. The shapes of the protruding portions 42, 43, 47 and 48 are determined so that the abutment occurs at the same time.

As described above, according to the hammer 41 and the anvil 46, since striking is performed at two portions symmetrical with each other with respect to a rotating axis, a balance during the striking is good so that the impact tool 1 can hardly be swung during the striking. Further, since the striking-side surfaces are respectively provided in both the sides in the circumferential direction of the protruding portions, the striking can be performed not only during a normal rotation, but also during a reverse rotation. Thus, a convenient impact tool can be realized. Further, since a direction in which the anvil 46 is struck by the hammer 41 is only a circumferential direction, and the hammer 41 does not strike the anvil in the axial direction nor forward, the end tool is not pressed to a fastened member more than necessary during the impact mode. Thus, there is advantage when fastening a wood screw, and the like, to wood.

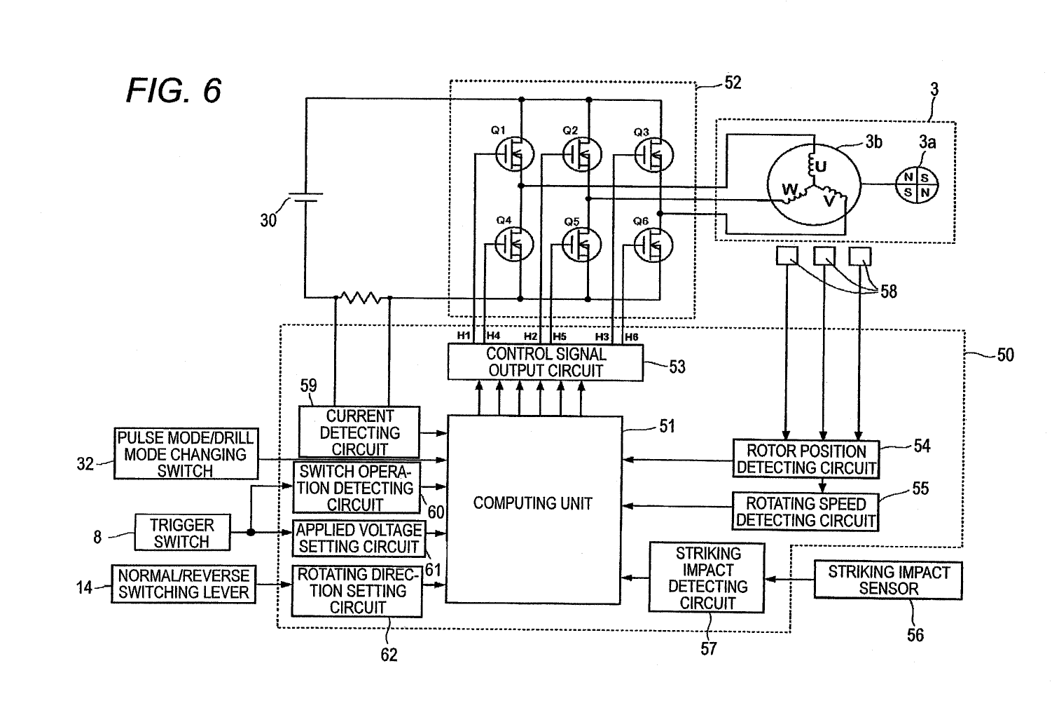

A structure and an operation of a driving control system of the motor 3 will be described hereinafter by referring to FIG. 6. FIG. 6 is a block diagram showing the structure of the driving control system of the motor 3. In the exemplary embodiment, the motor 3 is formed by the brushless DC motor of three phases. The brushless DC motor is a so-called inner rotor type and includes a rotor 3a including a permanent magnet having a plurality of sets (two sets in the exemplary embodiment) of N poles and S poles, a stator 3b including star-connected stator windings U, V and W of three phases and three rotating position detecting elements (hall elements) 58 arranged at predetermined intervals, for instance, at intervals of angles of 60° in the circumferential direction to detect the rotating position of the rotor 3a. In accordance with position detecting signals from the rotating position detecting elements 58, a current supply direction and time to the stator windings U, V and W are controlled and the motor 3 is rotated. The rotating position detecting elements 58 are provided at positions opposed to the permanent magnet 3c of the rotor 3a on the board 7.

An electronic element includes an inverter circuit 52 having six switching elements Q1 to Q6 such as FETs connected in a three-phase bridge form. Gates of the six bridge-connected switching elements Q1 to Q6 are respectively connected to a control signal output circuit 53 mounted on the control circuit board 9 and drains or sources of the six switching elements Q1 to Q6 are respectively connected to the star-connected stator windings U, V and W. Thus, the six switching elements Q1 to Q6 carry out switching operations in accordance with switching element driving signals (driving signals of H4, H5 and H6) inputted form the control signal output circuit 53 to supply an electric power to the stator windings U, V and W by considering DC voltage of the battery pack 30 applied to the inverter circuit 52 as three-phase (a U phase, a V phase and a W phase) voltages Vu, Vv, Vw.

Three negative power source side switching elements Q4, Q5 and Q6 of the switching element driving signals (three-phase signals) for driving the gates of the six switching elements Q1 to Q6 respectively are supplied as pulse width modulation signals (PWM signals) H4, H5 and H6, and pulse widths (duty ratio) of the PWM signals are changed by a computing unit 51 mounted on the control circuit board 9 in accordance with a detecting signal of an operation amount (a stroke) of the trigger operating portion 8a of the trigger switch 8 to adjust an amount of the supply of electric power to the motor 3 and control the start/stop and the rotating speed of the motor 3.

Here, the PWM signals are supplied either to positive power source side switching elements Q1 to Q3 or to the negative power source side switching elements Q4 to Q6 of the inverter circuit 52. The switching elements Q1 to Q3 or the switching elements Q4 to Q6 are switched at high speed to control the electric power supplied respectively to the stator windings U, V and W from the DC voltage of the battery pack 30. In the exemplary embodiment, since the PWM signals are supplied to the negative power source side switching elements Q4 to Q6, the pulse widths of the PWM signals are controlled so that the electric power supplied respectively to the stator windings U, V and W may be adjusted and the rotating speed of the motor 3 may be controlled.

In the impact tool 1, the normal/reverse switching lever 14 is provided for switching the rotating direction of the motor 3. Every time that a rotating direction setting circuit 62 detects a change of the normal/reverse switching lever 14, the rotating direction setting circuit 62 switches the rotating direction of the motor and transmits a control signal to the computing unit 51. The computing unit 51 includes a central processing unit (CPU) for outputting a driving signal in accordance with a processing program and data, a ROM for storing the processing program or control data, a RAM for temporarily storing the data, a timer and the like, which are not shown in the drawing.

The control signal output circuit 53 generates the driving signals for alternately switching predetermined switching elements Q1 to Q6 in accordance with output signals of the rotating direction setting circuit 62 and a rotor position detecting circuit 54 and outputs the driving signals to the control signal output circuit 53. Thus, a current is alternately supplied to a predetermined winding of the stator windings U, V and W to rotate the rotor 3a in a set rotating direction. In this case, the driving signals applied to the negative power source side switching elements Q4 to Q6 are outputted as the PWM modulation signals in accordance with an output control signal of an applied voltage setting circuit 61. A current magnitude supplied to the motor 3 is measured by a current detecting circuit 59 and the value is fed back to the computing unit 51 so that the current is adjusted so as to have a set driving electric power. The PWM signals may be supplied to the positive power source side switching elements Q1 to Q3.

A rotating speed detecting circuit 55 is a circuit having a plurality of signals of a rotor position detecting circuit 54 as inputs to detect the rotating speed of a motor 3 and output the rotating speed to a computing unit 51. A striking impact sensor 56 detects a level of an impact arising in an anvil 46 and an output thereof is inputted to the computing unit 51 through a striking impact detecting circuit 57. The striking impact sensor 56 can be realized by, for instance, an acceleration sensor attached to a control circuit board 9. When a fastening operation is completed by using an output of the striking impact sensor 56, the motor 3 may be automatically stopped.

The impact tool 1 according to the present exemplary embodiment can be driven in a “continuous driving mode” and an “intermittent driving mode”. The “continuous driving mode” is a simple control mode that a hammer is continuously driven and rotated to continuously rotate the anvil in one direction. The “intermittent driving mode” means a control mode that the hammer is normally rotated and stopped or normally rotated and reversely rotated to strike the anvil by the hammer and generate a strong fastening torque in the anvil. In the “intermittent driving mode”, since the hammer 41 needs to be normally rotated and reversely rotated to strike the anvil 46, a special driving control of the motor 3 is carried out. A control by the intermittent driving mode is a unique control method which can be realized by the hammer 41 and the anvil 46 according to the present exemplary embodiment. In the intermittent driving mode, since a striking operation is carried out by the hammer 41, a fastening angle per time is smaller than that in the continuous driving mode. Thus, when a fastening operation is carried out by the striking operation, during an initial period of the fastening operation in which a necessary torque may be low, the impact mechanism is driven in the continuous driving mode. When a reaction force of the object to be fastened is strong and the necessary fastening torque is increased, the continuous driving mode is switched to the intermittent driving mode. Thus, a total time necessary for the fastening operation in an impact mode may be shortened.

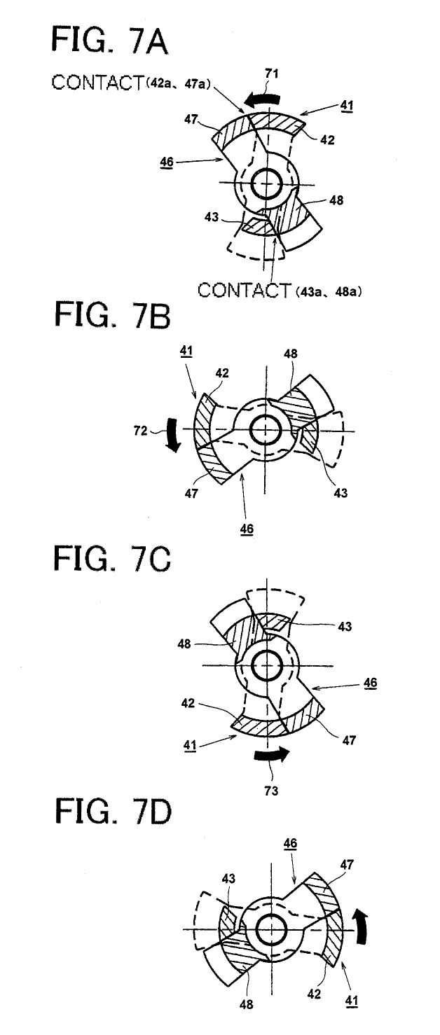

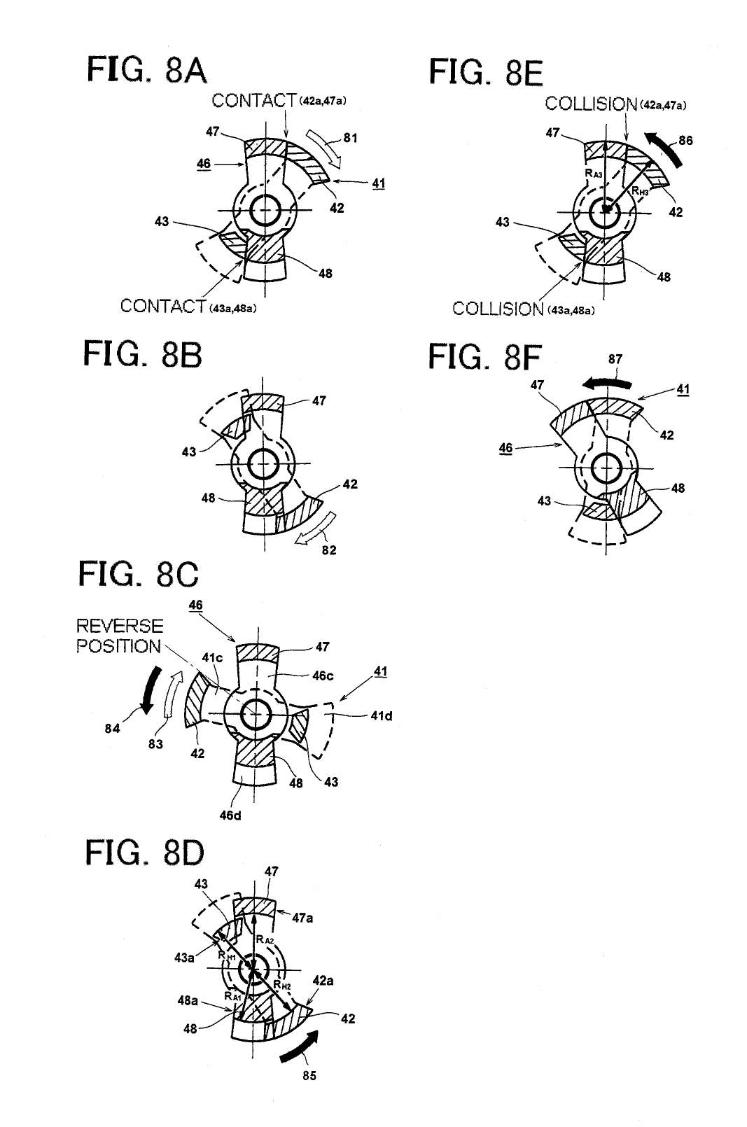

Now, the rotating operations of the hammer 41 and the anvil 46 will be described below by referring to FIG. 7 (7A, 7B, 7C, 7D) and FIG. 8 (8A, 8B, 8C, 8D, 8E, 8F). FIG. 7 is a sectional view taken along a line A-A in FIG. 3 and is a diagram for explaining a basic driving control of the hammer 41 in the above-described “continuous driving mode”. From these sectional views, positional relations can be understood between protruding portions 42 and 43 which protrude in the axial direction from the hammer 41 and protruding portions 47 and 48 which protrude in the axial direction from the anvil 46. A rotating direction of the anvil 46 during the fastening operation (during a normal rotation) is counterclockwise in FIG. 7. The hammer 41 is rotated in order of FIG. 7A, FIG. 7B, FIG. 7C and FIG. 7D by the driving of the motor 3. At this time, since the hammer 41 is continuously rotated in directions shown by arrow marks 71, 72, 73 and 74 by the driving of the motor 3, the anvil 46 is pressed from a rear part by the hammer 41. Under a state that striking-side surfaces 42a and 43a of the hammer 41 come into contact with struck-side surfaces 47a and 48a of the anvil 46, the anvil 46 is also synchronously rotated in the directions shown by the arrow marks.

In the “continuous driving mode” shown in FIG. 7, the fastening operation is considered to be carried out under a state that a rotation torque of the motor 3 for driving the hammer 41 is larger than the reaction force receiving from a fastened member. Under a state that a load is small during the fastening operation, only when the hammer 41 is rotated by the motor 3, the anvil 46 can be also synchronously rotated. Accordingly, the fastening operation can be carried out at high speed by using the “continuous driving mode” during an initial period of the fastening operation by the impact mode.

FIG. 8 is a sectional view taken along a line A-A in FIG. 3 and a diagram for explaining a basic driving control of the hammer 41 in the above-described “intermittent driving mode” of the impact tool 1. In the “intermittent driving mode”, not only the hammer 41 is rotated in one direction, but also the hammer 41 is moved forward and backward by driving the motor 3 in a special method to strike the anvil 46 by hammer 41. FIG. 8A is a diagram showing an initial state. This state shows a state immediately after being switched to the “intermittent driving mode” from another driving mode such as “the continuous driving mode”. From this state, the reverse rotation of the motor 3 is started, so that the hammer 41 is rotated in a direction shown by an arrow mark 81 (an opposite direction to the rotating direction of the anvil 46).

The hammer 41 and the anvil 46 can be rotated by a relative angle smaller than 360 degrees, and only the hammer 41 can be reversely rotated from the state shown in FIG. 8A. When the motor 3 is reversely rotated to a state near a state shown in FIG. 8B, a reversely rotating drive of the motor 3 is stopped, however, the hammer 41 is continuously rotated in a direction shown by an arrow mark 82 due to inertia and reversely rotated to a position shown in FIG. 8C. Immediately before the position shown in FIG. 8C, when a driving current in a normally rotating direction is supplied to the motor 3 to normally rotate the motor, the rotation of the hammer 41 in a direction shown by an arrow mark 83 is stopped to start a rotation (a rotation in a normal direction) in a direction shown by an arrow mark 84. Here, a position where the hammer 41 is reversely rotated is referred to as a “reverse position”. In this exemplary embodiment, a rotation angle from a start of a reverse rotation to the reverse position of the hammer 41 is about 240 degrees. In order to reversely rotate the hammer 41, the motor 3 needs to be reversely rotated by an inverse number of the reduction gear ratio of a planetary gear speed-reduction mechanism 21 to this angle. This reverse angle may be arbitrarily set within a maximum reverse angle and is preferably set in accordance with a required value of the magnitude of the fastening torque obtained by the striking.

When the hammer 41 is reversely rotated, the hammer 41 is normally rotated again. As shown in FIG. 8D, the protruding portion 42 passes again an outer peripheral side of the protruding portion 48 and the protruding portion 43 passes an inner peripheral side of the protruding portion 47 at the same time, and the hammer is accelerated and continuously rotated in a direction shown by an arrow mark 85. In such a way, to allow both the protruding portions 42 and 43 to pass, an inside diameter R_{H2} of the protruding portion 42 is formed to be larger than an outside diameter R_{A1} of the protruding portion 48, so that both the protruding portions 42 and 48 do not collide with each other. Similarly, an outside diameter R_{H1} of the protruding portion 43 is formed to be smaller than an inside diameter R_{A2} of the protruding portion 47. Thus, both the protruding portions 43 and 47 do not collide with each other. According to such a positional relation, the relative rotation angle of the hammer 41 and the anvil 46 can be formed to be larger than 180 degrees and a sufficient amount of the reverse angle of the hammer 41 relative to the anvil 46 can be ensured. The reverse angle may be set as an accelerating block before the hammer 41 applies a striking to the anvil 46.

Then, when the hammer 41 is accelerated in a direction shown by an arrow mark 86 and rotated to a state shown in FIG. 8E, the striking-side surface 42a of the protruding portion 42 collides with the struck-side surface 47a of the protruding portion 47. At the same time, the striking-side surface 43a of the protruding portion 43 collides with the struck-side surface 48a of the protruding portion 48. In such a way, since the hammer collides with the anvil 46 at two positions opposite to each other with respect to a rotating axis, the hammer 41 can apply the striking of a good balance to the anvil 46.

As a result of the striking, as shown in FIG. 8F, the anvil 46 is struck from a rear part by the hammer 41 to be rotated in a direction shown by an arrow mark 87. Thus, a fastened member is fastened by the rotation caused by the striking. The hammer 41 includes the protruding portion 42 as the only protrusion at a concentric position in the diametrical direction (at a position of R_{H2} or larger and R_{H3} or smaller) and the protruding portion 43 as the only protrusion at a concentric position (a position of R_{H1} or smaller). Further, the anvil 46 has the protruding portion 47 as the only protrusion at a concentric position in the diametrical direction (a position of R_{A2} or larger and R_{A3} or smaller) and the protruding portion 48 as the only protrusion at a concentric position (a position of R_{A1} or smaller). As described above, in the “intermittent driving mode”, the motor 3 is alternately rotated in a normal direction and a reverse direction to alternately rotate the hammer 41 in the normal direction and the reverse direction so that the striking is applied to the anvil 46.

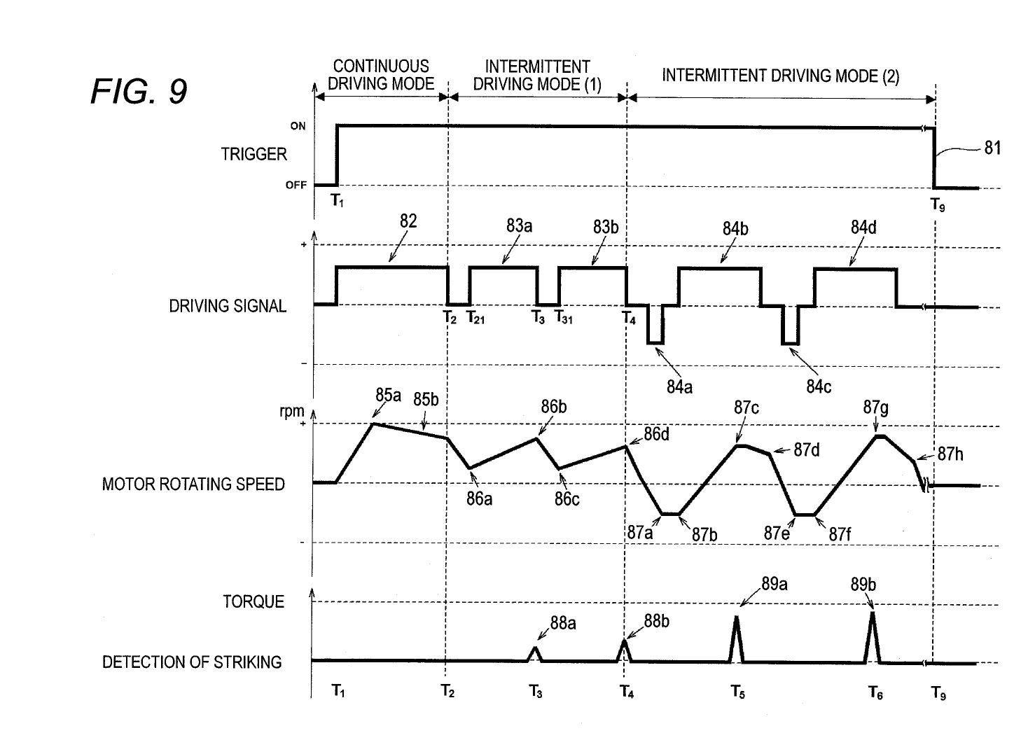

Now, a driving method of the impact tool 1 according to the exemplary embodiment will be described below by referring to FIG. 9. In the impact tool 1 according to the exemplary embodiment, the anvil 46 and the hammer 41 are formed so that the anvil and the hammer may relatively rotate at a rotation angle smaller than 360 degrees. Accordingly, since the hammer 41 cannot rotate by one turn or more relative to the anvil 46, a rotation control thereof is unique. FIG. 9 is a diagram showing a trigger signal during an operation of the impact tool 1, a driving signal of an inverter circuit, the rotating speed of the motor 3 and a state of striking of the hammer 41 and the anvil 46. In each graph, a horizontal axis shows a time and the horizontal axes are respectively arranged to mutually correspond so that timings of the graphs may be respectively mutually compared.

In the impact tool 1 according to the exemplary embodiment, in the case of the fastening operation in the impact mode, initially, the fastening operation is carried out at high speed in the continuous driving mode of the motor 3. When a necessary fastening torque value is large, the fastening operation is carried out by switching the continuous driving mode to the intermittent driving mode (1) of the motor 3. When the necessary fastening torque value is larger, the fastening operation is carried out by switching the intermittent driving mode (1) to the intermittent driving mode (2). In the continuous driving mode from time T₁ to T₂ in FIG. 9, a computing unit 51 controls the motor 3 in accordance with a target rotating speed. Accordingly, the computing unit 51 controls the motor 3 to be accelerated after a start until the motor 3 reaches the target rotating speed shown by an arrow mark 85a. In the continuous driving mode, the anvil 46 is pressed by the hammer 41 when rotating. Here, the hammer 41 is synchronously continuously rotated in accordance with a continuous rotation of a rotor 3a. The ratio of the rotating speed of the rotor 3a to the rotating speed of the hammer 41 may be set to 1:1, however, a predetermined reduction gear ratio is preferably set. After that, when a fastening reaction force from an end tool attached to the anvil 46 is increased, since the reaction force transmitted to the hammer 41 from the anvil 46 is increased, the rotating speed of the motor 3 is gradually lowered as shown by an arrow mark 85b. Thus, the fall of the rotating speed is detected by a value of the current supplied to the motor 3. At the time T₂, the continuous driving mode is switched to the intermittent driving mode (1) of the motor 3.

The intermittent driving mode (1) is a mode in which the motor 3 is not continuously driven, but is intermittently driven, and the motor 3 is driven in a pulsating way so that a “[stop] to [normally rotating drive]” is repeated a plurality of times. Here, “driven in a pulsating way” means a driving control in which a gate signal applied to the inverter circuit 52 is allowed to pulsate so as to allow a driving current supplied to the motor 3 to pulsate, so that the rotating speed of the motor 3 or an output torque is allowed to pulsate. This pulsation is generated by repeating ON-OFF of the driving current for a large period (for instance, about several ten Hz to one hundred and several ten Hz) in such a way that the driving current supplied to the motor is turned off (stopped) from the time T₂ to T₂₁, the driving current of the motor is turned on (driven) from time T₂₁ to T₃, the driving current is turned off (stopped) from time T₃ to T₃₁ and the driving current is turned on from time T₃₁ to T₄. When the driving current is turned on, a PWM control is carried out to control the rotating speed of the motor 3. The period of pulsation is adequately smaller than a period for controlling the duty ratio thereof (ordinarily several KHz).

In an example shown in FIG. 9, after the supply of the driving current to the motor 3 is stopped for a predetermined time from the time T₂ and the rotating speed of the motor 3 is lowered to a value shown by an arrow mark 86a, the computing unit 51 (see FIG. 6) transmits a driving signal 83a to a control signal output circuit 53 to supply a pulsating driving current (a driving pulse) to the motor 3 and accelerate the motor 3. A control during the acceleration does not necessarily mean a driving in the duty ratio of 100%, but may indicate a control in the duty ratio lower than 100%. Then, at a spot shown by an arrow mark 86b, the hammer 41 strongly collides with the anvil 46, so that a striking force is applied as shown by an arrow mark 88a. When the striking force is applied to the anvil 46, the supply of the driving current to the motor 3 is stopped again for a predetermined time. After the rotating speed of the motor 3 is lowered as shown by an arrow mark 86c, the computing unit 51 transmits a driving signal 83b to the control signal output circuit 53 to accelerate the motor 3. Then, at a spot shown by an arrow mark 86d, the hammers 41 strongly collide with the anvil 46 to apply the striking force as shown by an arrow mark 88b. In the intermittent driving mode (1), an intermittent driving in which the above-described “[stop] to [normally rotating drive]” of the motor 3 is repeated is repeated once or a plurality of times. When a higher fastening torque is necessary, this state is detected to switch the intermittent driving mode (1) to a rotating and driving mode by the intermittent driving mode (2). It can be decided whether or not the high fastening torque is necessary, for instance, by using the rotating speed of the motor 3 (a rotating speed in the vicinity of the arrow mark 86d) when the striking force shown by the arrow mark 88d is applied.

The intermittent driving mode (2) is a mode in which the motor 3 is intermittently driven to drive the motor 3 in a pulsating way like the intermittent driving mode (1) so that a “[stop] to [reversely rotating drive] to [stop] and to [normally rotating drive]” is repeated a plurality of times. Namely, in the intermittent driving mode (2), since not only the normally rotating drive of the motor 3, but also a reversely rotating drive is added, after the hammer 41 is reversely rotated by a sufficient relative angle to the anvil 46 as shown in FIG. 8, the hammer 41 is accelerated in a normally rotating direction and allowed to vigorously collide with the anvil 46. The hammer 41 is alternately driven both in the normal direction and the reverse direction in such a way to generate a strong fastening torque in the anvil 46.

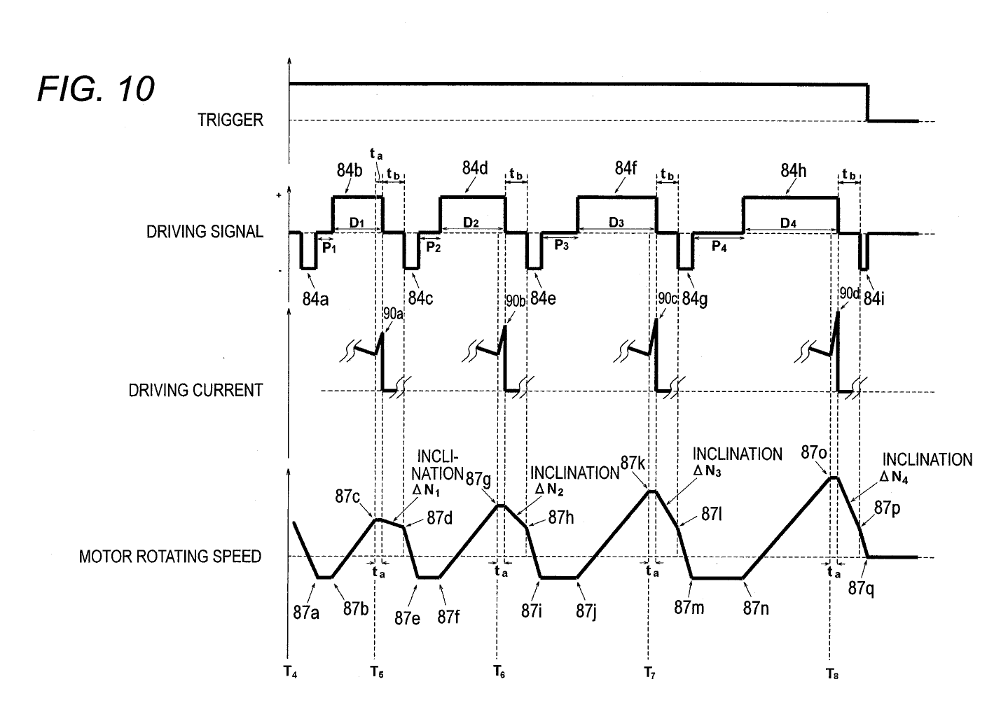

In FIG. 9, when the intermittent driving mode (1) is switched to the intermittent driving mode (2) at the time T₄, the driving of the motor 3 is temporarily stopped. Then, a driving signal 84a of a negative direction is transmitted to the control signal output circuit 53 to reversely rotate the motor 3. A normal rotation and a reverse rotation are realized by switching signal patterns of the driving signals (on-off signals) respectively outputted to switching elements Q1 to Q6 from the control signal output circuit 53. When the motor 3 is reversely rotated by a predetermined rotation angle (an arrow mark 87a), the driving of the motor 3 is temporarily stopped. When the driving of the motor 3 is stopped, since a driving voltage is not supplied to the motor 3, the motor 3 is rotated due to inertia. After that, since the driving of the motor in the normally rotating direction is started (an arrow mark 87b), a driving signal 84b of a positive direction is transmitted to the control signal output circuit 53. In a rotating and driving operation using the inverter circuit 52, the driving signal is not switched to a plus side or a minus side, however, in FIG. 10, in order to easily understand to which direction the rotating and driving operation is carried out, the driving signals are divided into and schematically expressed in a direction of + and a direction of −.

In the vicinity of a part where the rotating speed of the motor 3 reaches a maximum speed, the hammer 41 collides with the anvil 46 (an arrow mark 87c). In accordance with this collision, a fastening torque (an arrow mark 89a) is generated that is extremely larger than the fastening torque (88a, 88b) generated in the intermittent driving mode (1). In the exemplary embodiment, the driving signal is continuously supplied to the motor for a predetermined time after the collision. However, the driving signal to the motor 3 may be controlled to stop the moment the collision shown by the arrow mark 89a is detected. In that case, when an object to be fastened is a bolt or a nut, a reaction transmitted to the hand of an operator after the striking may be reduced. As in the exemplary embodiment, even after the collision, since the driving current is supplied to the motor 3, a reaction force applied to the operator is smaller than that in the continuous driving mode. Thus, the intermittent driving mode is suitable for an operation under a state of an intermediate load. Further, a fastening speed is high and electric power consumption can be effectively reduced more than that in a strong pulse mode.

After that, the driving of the motor 3 is temporarily stopped. Then, a driving signal 84c of a negative direction is transmitted to the control signal output circuit 53 to reversely rotate the motor 3. Then, a “[stop] to [reversely rotating drive] to [stop] and to [normally rotating drive]” is similarly repeated a predetermined number of times to carry out the fastening operation by the strong fastening torque. At time T₉, the operator releases a trigger operation to stop the motor 3 and complete the fastening operation. The completion of the operation is carried out not only by releasing the trigger operation by the operator. When the computing unit 51 decides that the fastening operation is completed by the set fastening torque, the computing unit 51 may control the driving of the motor 3 to stop. A method for detecting the fastening torque will be described later.

FIG. 10 shows a control of the intermittent driving mode (2) part shown in FIG. 9 and is a diagram showing a relation between the driving signal to the inverter circuit, an operating current supplied to the motor and the rotating speed of the motor. When the control is switched to the intermittent driving mode (2) from the intermittent driving mode (1) at the time T₄, the computing unit 51 temporarily stops the driving of the motor 3. Then, the computing unit transmits a driving signal 84a of a negative direction to the control signal output circuit 53 to reversely rotate the motor 3. The computing unit 51 supplies the driving signal 84a of the negative direction for a predetermined time, so that the rotating speed of the motor 3 reaches a predetermined reversely rotating speed shown by an arrow mark 87a. Then, the computing unit 51 temporarily stops the driving of the motor 3 for a time P₁. During that time, the motor 3 substantially maintains a reversely rotating speed and rotates due to inertia. When the stop time P₁ elapses, the computing unit 51 starts to drive the motor 3 to normally rotate (an arrow mark 87b). The normally rotating drive is carried for a normally rotating drive time D₁. Immediately before the D₁ elapses (at a time T₅), the hammer 41 collides with the anvil 46. Thus, a striking is applied to the anvil 46 so that the strong fastening torque is generated in the anvil 46 due to the striking. Default values may be preferably previously set as the time P₁ and the normally rotating drive time D₁ immediately after the intermittent driving mode (1) shifts to the intermittent driving mode (2). When a time tₐ elapses after the striking operation is carried out, the computing unit 51 measures a driving current value I₁ (a magnitude of a peak value shown by an arrow mark 90a) to the motor 3.

In accordance with an experiment by the inventor et al., it is recognized that the magnitude of a peak current Iₘ, immediately after an mth striking after the shift to the intermittent driving mode (2) is substantially proportional to a fastening torque value TRₘ due to the striking. The fastening torque value TRₘ during the mth striking in the intermittent driving mode (2) can be expressed as described below. TRₘ=k·ΔIₘ (k: proportional constant, m=1, 2, . . . , n). The torque value TRₘ serves as a reference for setting a stop time Pₘ₊₁ after a next reversely rotating current and a normally rotating drive time Dₘ₊₁ to which a normally rotating current is applied. The stop time Pₘ₊₁ and the normally rotating drive time Dₘ₊₁ are set on the basis of the obtained torque value TRₘ. A method of setting them may be calculated by a predetermined computing expression. Further, a relation between the torque value TRₘ, the stop time Pₘ₊₁ ad the normally rotating drive time Dₘ₊₁ may be previously stored in a storage device not shown in the drawing in the computing unit 51 as a data table.

Then, after the obtained peak current I₁ is measured, a stop time t_{b} is provided. Then, the computing unit 51 supplies a driving signal 84c of a negative direction and controls the motor 3 to reach a predetermined reversely rotating speed, for instance, −3000 rpm. When the motor reaches the predetermined reversely rotating speed shown by an arrow mark 87e, the computing unit stops the supply of the driving signal 84c. A stop time P₂ at this time is determined in accordance with a fastening torque value TR₁ obtained during a first striking. Here, an mth stop time Pₘ is preferably more increased, as a fastening torque value TRₘ₋₁ is larger. To increase the stop time Pₘ means that a period is lengthened during which the hammer 41 is reversely rotated due to inertia within a range from FIG. 8B to FIG. 8C. As a result, a reverse angle of the hammer 41 is large and a reverse position is located in a rear side. When the reverse angle of the hammer 41 is large, a previous running distance of a next striking is long. Accordingly, a rotating speed of a normal direction is high when the hammer 41 applies the striking to the anvil 46, so that a larger fastening torque value TRₘ can be generated.

The motor 3 accelerated in a normally rotating direction from a spot shown by an arrow mark 87f has a rotating speed that reaches a peak at a spot shown by an arrow mark 87g, that is, at a time T₆ and applies a striking to the anvil 46. After the striking operation is performed, when the time tₐ elapses similarly to the first striking, the computing unit 51 measures a driving current value I₂ (the magnitude of a peak value shown by an arrow mark 90b) and calculates a fastening torque value TR₂ by using the above-described expression. After that, the computing unit temporarily stops the driving of the motor 3 for the time t_{b}. The same operations are repeated in the following. At a time T₇, a third striking operation is carried out and at a time T₈, a fourth striking operation is carried out. Further, during the striking operations respectively, the fastening torque value TRₘ is calculated and the stop time Pₘ₊₁ is determined. Then, at a time T₉, the operator releases a trigger operation to stop the motor 3.

As described above, the inventor et al. established a method for detecting the fastening torque value TRₘ by using the magnitude of the peak current Iₘ of the driving current. As a result, in the impact tool, an optimum striking can be controlled to be applied in accordance with the level of a fastening load, wasteful energy consumption can be suppressed and an electric power can be saved.

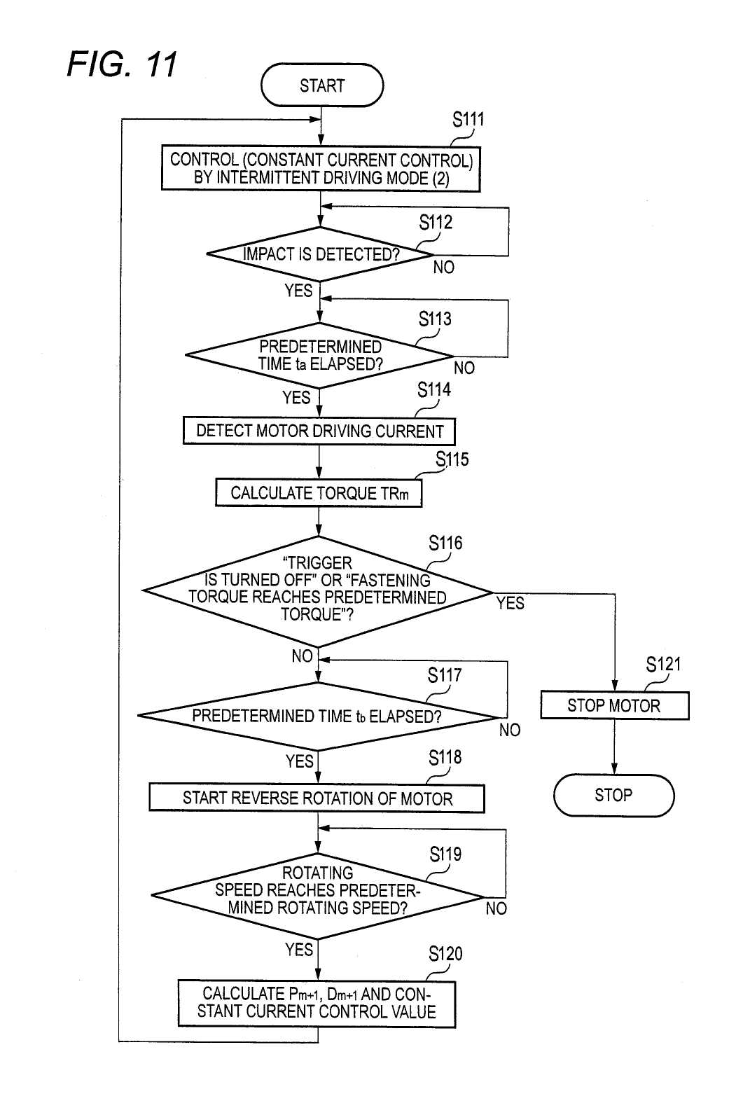

Now, by referring to a flowchart shown in FIG. 11, a control procedure in the intermittent mode (2) of the impact tool 1 according to the exemplary embodiment of the present invention will be described. Initially, when the driving in the intermittent driving mode (1) shown in FIG. 9 is finished, the intermittent driving mode (1) is shifted to the intermittent driving mode (2) (S111). In the intermittent driving mode (2), as shown in FIG. 10, the current is supplied in order of a stop, a current for rotating the motor in a reverse direction, a stop and a current for rotating the motor in a normal direction to allow the hammer 41 to collide with the anvil 46. When supplying the current for driving the motor in the normal direction, the motor 3 is driven by a predetermined current of, for instance, 50A in accordance with a constant current control to accelerate the hammer 41 in a normally rotating direction from an initial position, so that the hammer 41 is collides with the anvil 46. In this collision, since not only the inertia of the hammer 41, but also the inertia of a rotor 3a can be used, even the relatively light hammer 41 can generate a strong striking force. During a first striking in the intermittent driving mode (2), as the stop time P₁ and the normally rotating drive time D₁, the previously set default values are used. When supplying the current for rotating the motor in the reverse direction, the constant current control is carried out. Then, whether the striking is detected or not, is detected. When the striking is not detected, the procedure is held until the striking is detected (S112). The striking is detected by a striking impact sensor 56 (see FIG. 6). When the striking is detected, the procedure is held until the predetermined time tₐ elapses (S113). When the predetermined time tₐ elapses, the driving current of the motor 3 is measured to detect the peak current Iₘ (S114). The measurement is carried out by using a current detecting circuit 59 (see FIG. 6).

Then, the fastening torque value TRₘ is calculated on the basis of the obtained peak current Iₘ (S115). Subsequently, it is decided whether or not the fastening torque value TRₘ reaches a previously set predetermined fastening torque or whether or not the operator turns off a trigger switch 8 (S116). When the fastening torque value reaches the predetermined fastening torque or when the trigger switch 8 is turned off, the rotation of the motor 3 is stopped (S121) to finish a fastening operation.

In S116, when the fastening torque value does not reach the predetermined torque value, and when the trigger switch 8 is not turned off, it is decided whether or not a stop time t_{b} further elapses (namely, whether or not the time tₐ+t_{b} elapses after the striking is detected), and when the stop time t_{b} does not elapse, the procedure is held (S117). When the stop time t_{b} elapses, the current for rotating the motor in the reverse direction is supplied to the motor 3 to (S118). Then, it is detected whether or not the rotating speed of the motor 3 reaches a predetermined reversely rotating speed (for instance, −3000 rpm), and when the rotating speed does not reach the predetermined reversely rotating speed, the constant current control is continuously performed and the procedure is held until the rotating speed of the motor reaches the predetermined reversely rotating speed (S119). When the rotating speed of the motor reaches the predetermined reversely rotating speed, the supply of the reversely rotating current is stopped to calculate the stop time Pₘ₊₁ and the normally rotating drive time Dₘ₊₁ from the fastening torque value TRₘ obtained in S115 and a constant current control value in a next normally rotating drive and return to S111 (S120). Here, when the fastening torque value TRₘ is large, the constant current control value in the next normally rotating drive is increased, and when the fastening torque value TRₘ is small, the constant current control value in the next normally rotating drive is decreased. A relation between the constant current control value and the fastening torque value TRₘ may be preferably previously stored in the storage device not shown in the drawing in the computing unit 51 in the form of a data table or a function.

As described above, in the exemplary embodiment, since the magnitude of the fastening torque by the anvil is calculated in accordance with the magnitude of the driving current supplied to the motor 3 immediately after the striking, a torque detecting unit can be realized without separately using a torque detector such as a distortion sensor and a fastening load can be detected for each striking so as to effectively give an influence on the control of the motor, and a fastening operation can be accurately performed. In S117, after the predetermined stop time t_{b} elapses, the current for rotating the motor in the reverse direction is supplied to the motor 3. However, the current for reversely rotating the motor 3 may be supplied to the motor 3 when the rotating speed of the motor 3 is lowered to a predetermined rotating speed (for instance, 5000 rpm).

In the exemplary embodiment, the magnitude of the fastening torque by the anvil is calculated in accordance with the magnitude of the driving current supplied to the motor 3 immediately after the striking. However, the magnitude of the fastening torque by the anvil may also be calculated in accordance with, for example, an average of a magnitude of a current supplied to the motor 3 after the striking and a magnitude of a current supplied to the motor 3 after the time tₐ.

### Second Exemplary Embodiment

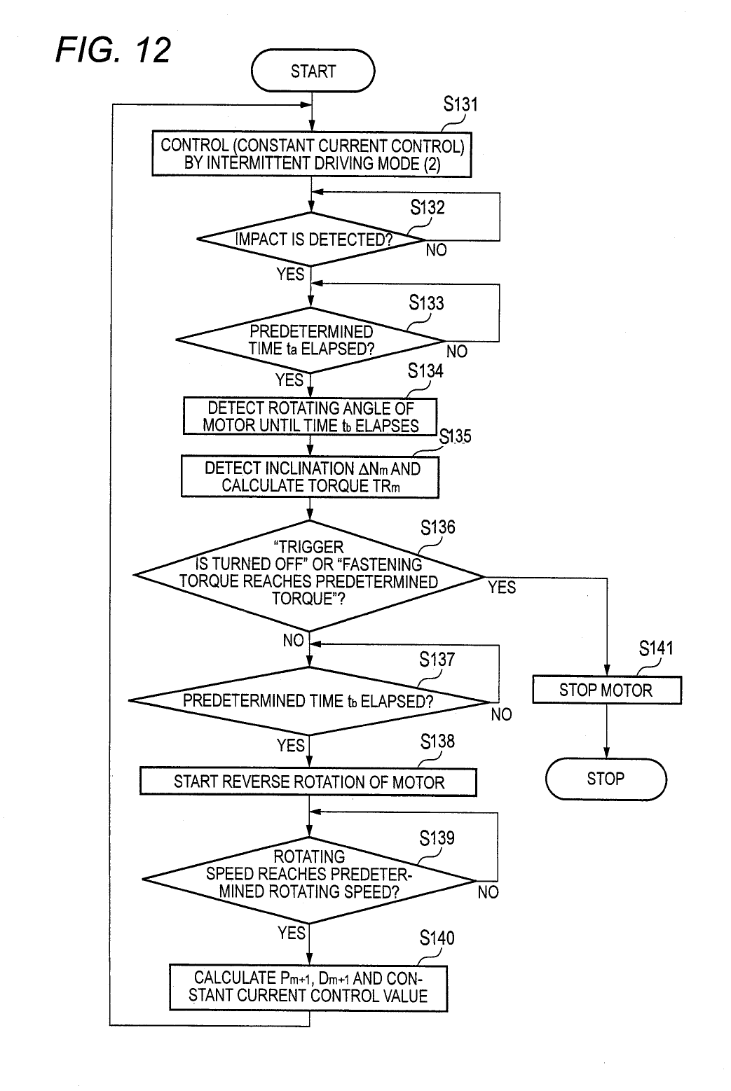

Hereinafter, referring to FIG. 10 and FIG. 12, a control procedure in an intermittent driving mode (2) of an impact tool 1 according to a second exemplary embodiment of the present invention will be described. In the second exemplary embodiment, a control method of a motor 3 is the same as that of the first exemplary embodiment. However, a fastening torque value TRₘ is not detected by using a peak current Iₘ supplied to the motor 3 after a striking, but detected by using a degree of fall of a rotating speed of the motor after the striking. In FIG. 10, at a time shown by an arrow mark 87c, when a time tₐ elapses after the striking is applied, a computing unit 51 temporarily stops the driving of the motor 3 for a time t_{b}. At this time, the computing unit 51 monitors the fall of the rotating speed of the motor 3 during the elapse of the time t_{b} to calculate an inclination ΔN₁ of a rotating speed curve.

The inclination ΔN₁ shows the degree of fall of the rotating speed of the motor 3 immediately after a driving current is continuously supplied for a short period of time after the striking and the driving current is stopped. The large inclination ΔN₁ means that a fastening torque by the striking is high. By an experiment of the inventor et al., it is recognized that the fastening torque value TRₘ is substantially inversely proportional to the inclination ΔNₘ. The fastening torque value TRₘ during an mth striking in the intermittent driving mode (2) can be expressed as described below.

TRₘ=−a·ΔNₘ(a: proportional constant, m=1, 2, . . . , n).

Further, the torque value TRₘ serves as a reference for setting a stop time Pₘ₊₁ after a next reversely rotating current and a normally rotating drive time Dₘ₊₁ to which a normally rotating current is applied. The stop time Pₘ₊₁ and the normally rotating drive time Dₘ₊₁ are set on the basis of the obtained torque value TRₘ. A method of setting them may be calculated by a predetermined computing expression. Further, a relation between the torque value TRₘ, the stop time Pₘ₊₁ and the normally rotating drive time Dₘ₊₁ may be previously stored in a storage device not shown in the drawing in the computing unit 51 as a data table.

Then, immediately after (an arrow mark 87d) the obtained inclination ΔN₁ is measured, the computing unit 51 supplies a driving signal 84c in a negative direction and controls the motor 3 to reach a predetermined reversely rotating speed, for instance, −3000 rpm. When the computing unit controls the rotating speed of the motor 3 to reach the predetermined reversely rotating speed shown by an arrow mark 87e, the computing unit stops the supply of the driving signal 84c. A stop time P₂ at this time is determined in accordance with a fastening torque value TR₁ obtained during a first striking. Here, an mth stop time Pₘ is preferably more increased, as a fastening torque value TRₘ₋₁ is larger. To increase the stop time Pₘ means that a period is lengthened during which a hammer 41 is reversely rotated due to inertia within a range from FIG. 8B to FIG. 8C. As a result, a reverse angle of the hammer 41 is large and a reverse position is located in a rear side. When the reverse angle of the hammer 41 is large, a previous running distance of a next striking is long. Accordingly, a rotating speed of a normal direction is high when the hammer 41 applies the striking to an anvil 46, so that a larger fastening torque value TRₘ can be generated.

The motor 3 accelerated in a normally rotating direction from a spot shown by an arrow mark 87f has a rotating speed that reaches a peak at a spot shown by an arrow mark 87g, that is, at a time T₆ and applies a striking to the anvil 46. After the striking operation is performed, when the time tₐ elapses similarly to the first striking, the computing unit 51 temporarily stops the driving of the motor 3 for the time t_{b}. At this time, the computing unit 51 monitors the degree of fall of the rotating speed of the motor 3 during the elapse of the time t_{b} to calculate an inclination ΔN₂ of a rotating speed curve. The computing unit repeats the same operations. At a time T₇, a third striking operation is carried out and at a time T₈, a fourth striking operation is carried out. Further, during the striking operations respectively, the computing unit calculates the fastening torque value TRₘ and determines the stop time Pₘ₊₁. Then, at a time T₉, when the operator releases a trigger operation, the motor 3 is stopped.

Now, by referring to a flowchart shown in FIG. 12, the control procedure in the intermittent mode (2) of the impact tool 1 according to the second exemplary embodiment of the present invention will be described below. Initially, when the driving in the intermittent driving mode (1) shown in FIG. 9 is finished, the intermittent driving mode (1) is shifted to the intermittent driving mode (2) (S131). In the intermittent driving mode (2), as shown in FIG. 10, the current is supplied in order of a stop, a current for rotating the motor 3 in the reverse direction, a stop, and a current for rotating the motor 3 in the normal direction, to allow the hammer 41 to collide with the anvil 46. Then, whether the striking is detected or not, is detected. When the striking is not detected, the procedure returns to S131. When the striking is detected, the procedure is held until the predetermined time tₐ elapses (S133). When the predetermined time tₐ elapses, the supply of the current for rotating the motor 3 in the normal direction is stopped to start detecting a rotation angle Δθ of the motor 3 (S134). The rotation angle Δθ can be detected by a rotor position detecting circuit 54 by the use of a rotating position detecting element 58 (see FIG. 6) provided in the motor 3.

Then, the rotation angle of the motor 3 is detected until the time t_{b} elapses after the supply of the current for rotating the motor 3 in the normal direction is stopped to obtained the rotation angle Δθ and calculate ΔNₘ. showing the degree of fall of the rotating speed of the motor 3. As shown in the above-described expression, the fastening torque value can be calculated by this ΔNₘ. Subsequently, in S136, it is decided whether or not the fastening torque value reaches a previously set predetermined fastening torque or whether or not the operator turns off a trigger switch 8 (S136). When the fastening torque value reaches the predetermined fastening torque or when the trigger switch 8 is turned off, the rotation of the motor 3 is stopped (S141) to finish a fastening operation.

In S136, when the fastening torque value does not reach the predetermined fastening torque value, and when the trigger switch 8 is not turned off, it is determined whether or not a stop time t_{b} further elapses (namely, whether or not the time tₐ+t_{b} elapses after the striking is detected), and when the stop time t_{b} does not elapse, the procedure is held (S137). When the stop time t_{b} elapses, the current for rotating the motor 3 in the reverse direction is supplied to the motor 3 (S138). A constant current control is applied to the current for rotating the motor 3 in the reverse direction. Then, it is detected whether or not the rotating speed of the motor 3 reaches a predetermined reversely rotating speed (for instance, −3000 rpm), and when the rotating speed does not reach the predetermined reversely rotating speed, the procedure is held until the rotating speed of the motor reaches the predetermined reversely rotating speed (S139). When the rotating speed of the motor reaches the predetermined reversely rotating speed, the stop time Pₘ₊₁ and the normally rotating drive time Dₘ₊₁ and a constant current control value in a next normally rotating drive are calculated from the fastening torque value TRₘ obtained in S135 to return to S131 (S140). Here, when the obtained Δθ is large, the constant current control value in the next normally rotating drive is increased, and when the Δθ is small, the constant current control value in the next normally rotating drive is decreased. A relation between the constant current control value and the rotation angle Δθ may be preferably previously stored in the storage device not shown in the drawing in the computing unit 51 in the form of a data table or may be calculated by a below-described expression:

Constant current control value=k·Δθ(k: proportional constant).

As described above, according to the second exemplary embodiment, since the fall of the rotating speed of the motor is detected immediately after the striking to calculate the magnitude of the fastening torque by the striking in accordance with a degree of a fall, the torque detecting unit can be realized without separately using a torque detector such as a distortion sensor and the fastening load can be detected for each striking so as to effectively give an influence on the control of the motor, and the fastening operation can be accurately carried out. The magnitude of the fastening torque by the anvil may be detected not only by detecting the fall of the rotating speed of the motor, but also by detecting an amount of rotation angle of the motor.

In the exemplary embodiment, the degree of the fall of the rotation speed of the motor was detected by the inclination of the rotating speed curve. However, the degree of the fall of the rotating speed can also be calculated by, for example, an average value of a value of the rotating speed curve after the time tₐ has elapsed and a value of the rotating speed curve after a predetermined time has elapsed.

The present invention has been described in accordance with the exemplary embodiments. However, the present invention is not limited thereto and various changes in form and details may be made therein without departing from the spirit and scope of the invention. For instance, when a graph is drawn in which a horizontal axis shows a time and a vertical axis shows a current (may also be a rotating speed or rotation angle), a current control value may be changed in accordance with a graph area (an integrated value) of the current.

This application claims priority from Japanese Patent Application No. 2010-055011 filed on Mar. 11, 2010, the entire contents of which are incorporated herein by reference.

### INDUSTRIAL APPLICABILITY

According to an aspect of the present invention, there is provided an impact tool that can realize an impact mechanism by a hammer and an anvil having simple structures and can accurately carry out a fastening operation by a predetermined fastening torque.

According to another aspect of the present invention, there is provided a compact and light impact tool that realizes a detecting unit of a fastening torque without attaching a sensor such as a distortion gauge to an anvil.

According to another aspect of the present invention, there is provided an impact tool that can accurately detect a fastening torque by detecting a current supplied to a motor immediately after a striking.

1. An impact tool comprising:
a motor;
a hammer connected to the motor; and
an anvil struck by the hammer by driving the motor alternately in a normal rotation and a reverse rotation,
wherein a magnitude of a fastening torque by the anvil is calculated in accordance with a current value of a current supplied to the motor immediately after the striking.

2. The impact tool according to claim 1,
wherein a driving current for driving the motor in a normal direction is continuously supplied to the motor for a time tₐ after the striking is performed, and
wherein the current value is detected within the time tₐ.

3. The impact tool according to claim 2,
wherein a peak current value is detected as the current value.

4. The impact tool according to claim 2,
wherein the current value is calculated by an average of a current value after the striking and a current value after the time tₐ.

5. The impact tool according to claim 2,
wherein the current value is detected by an inclination of a current value curve.

6. An impact tool comprising:
a motor;
a hammer connected to the motor; and
an anvil struck by the hammer by driving the motor alternately in a normal rotation and a reverse rotation,
wherein a fall of a rotating speed of the motor immediately after the striking is detected, and
wherein a magnitude of a fastening torque by the striking is calculated from a degree of the fall.

7. The impact tool according to claim 6,
wherein a driving current for rotating the motor in a normal direction is continuously supplied for a predetermined time after the striking is performed, and
wherein the degree of the fall of the rotating speed of the motor is detected after the supply of the driving current is stopped.

8. The impact tool according to claim 7,
wherein the driving current is continuously supplied for a time tₐ after the striking is performed, and
wherein the degree of the fall of the rotating speed is detected during a time t_{b} which starts after the time tₐ elapsed after the striking.

9. The impact tool according to claim 8,
wherein the degree of the fall of the rotating speed is detected by an inclination of a rotating speed curve.

10. The impact tool according to claim 8,
wherein the degree of the fall of the rotating speed is calculated by an average value of a value of the rotating speed curve after the time tₐ has elapsed and a value of the rotating speed curve after a time t_{c} has elapsed.
